(19) United States
(12) Patent Application Publication
(10) Pub. No.: US 2003/0212570 A1
(43) Pub. Date: Nov. 13, 2003

(54) System and method for inquiring remaining quantity of orders

(75) Inventors: Te-Mei Chu, Taipei (TW); Shu-Mei Chien, Taipei (TW); Yun-Chi Lee, Taipei (TW); Kuan-I Wu, Taipei (TW)

Correspondence Address: Finnegan, Henderson, Farabow,, Garrett & Dunner, L.L.P., 1300 I Street, N.W., Washington, DC, 20005-3315, US

(73) Assignee: INVENTEC CORPORATION

(21) Appl. No.: 10/226,220

(22) Filed: Aug. 23, 2002

(30) Foreign Application Priority Data
May 13, 2002 (TW) 91109872

(51) Int. Cl. G06F 17/60

(52) U.S. Cl. 705/1; 705/28

(57) ABSTRACT

A system and a method for inquiring remaining quantity of orders are provided. First, an order database for storing order data and a user database for storing users' data are established. Then, the system periodically searches and calculates quantity data of unprocessed orders and orders with undelivered products from the order database. Moreover, an identity recognizing module determines and retrieves access rights of a user from the user database according to an identification code inputted by the user. Further, the user with the access rights inputs inquiry conditions for remaining order data, and an order inquiry module retrieves remaining order data from the order database as inquired by the user. Finally, the retrieved remaining order data are displayed on a web page and browsed by the user.

### FIELD OF THE INVENTION

The present invention relates to systems and methods for inquiring remaining quantity of orders, and more particularly, to a system and a method for allowing a buyer and a seller to realize a status of order processing in real time e.g. quantity of unprocessed orders and orders with undelivered products, through the use of a communication network.

### BACKGROUND OF THE INVENTION

With wide application of Internet and World Wide Web (WWW) to business or commercial activities, electronic commerce (e-commerce) becomes a critical trading mode in communication between buyers and sellers. Therefore, many enterprises start to provide business services through the use of a network, for example, providing product catalogs on web pages for introducing product characteristics, prices and uses to buyers, or providing online product trading on the web pages for allowing the buyers to easily make orders, cancel orders, etc via the network.

When a buyer transmits a purchase order through the above e-commerce mode to a seller, if the seller's stock is insufficient that all ordered products listed on the purchase order cannot be delivered to the buyer at once, the seller would normally inform the buyer of a current product-stock status and quantity of delivered and undelivered products via a telephone, electronic mail or product invoice. However, this manual communication method would undesirably increase costs in human resources and consumption of paper and time.

The above one-way order processing mode of e-commerce cannot effectively integrate data of purchase orders and product stock, making a buyer not able to immediately realize a current status of order processing. On the other hand, a seller cannot in real time monitor and manage products in demand.

Therefore, the problem to be solved is to allow a buyer and a seller to realize a current status of order processing in real time in terms of integration of product order and stock data.

### SUMMARY OF THE INVENTION

An objective of the present invention is to provide a system and a method for inquiring remaining quantity of orders, for allowing a buyer and a seller to realize a status of order processing in real time.

Another objective of the invention is to provide a system and a method for inquiring remaining quantity of orders, for allowing a buyer to be informed of current data of unprocessed orders and orders with undelivered products, without having to use human resources of a seller for notifying the buyer of product stock.

In accordance with the above and other objectives, the present invention proposes a system and a method for inquiring remaining quantity of orders.

The system for inquiring remaining quantity of orders is linked with terminal devices of a buyer workstation and a seller workstation through a network, so as to perform ordering operation between buyers and sellers. The system comprises: a user database linked to a host used to receive orders from buyers, for storing a plurality of records of users' data; an order database for storing a plurality of orders generated from buyers; a quantity calculating module for periodically searching and calculating quantity data of unprocessed orders and orders with undelivered products by sellers from the order database; an identity recognizing module for determining and retrieving access rights of a user from the user database according to an identification code inputted by the user through a terminal device to the order processing system; and an order inquiry module for allowing the user with the determined access rights to input inquiry conditions for data of the unprocessed orders and orders with undelivered products, and for retrieving from the order database for the inquired order data to be displayed on the terminal device of the user.

The method for inquiring remaining quantity of orders links terminal devices of a buyer workstation and a seller workstation through a network to an order processing system, wherein the order processing system at least includes a quantity calculating module, an identity recognizing module, an order inquiry module, a user database for storing a plurality of records of users' data and identification codes respectively corresponding to the records of users' data, and an order database for storing a plurality of orders generated from buyers. The method comprises the steps of. periodically searching in the order database for data of unprocessed orders and orders with undelivered products by sellers via the quantity calculating module; inputting an identification code via a user through a terminal device of a buyer workstation or a seller workstation, and retrieving access rights of the user via the identity recognizing module from the user database according to the inputted identification code, wherein if the user's access rights are retrieved, the user is allowed to input inquiry conditions for the searched data of unprocessed orders and orders with undelivered products to the order processing system; and retrieving corresponding order data via the order inquiry module according to the user's access rights and inputted inquiry conditions, and displaying the retrieved order data through the network on the terminal device of the buyer or seller workstation of the user.

In the use of the above system and method for inquiring remaining quantity of orders, quantity data of unprocessed orders and orders with undelivered products are stored and provided for a buyer and a seller in real time; this is beneficial of reducing costs in human resources and time, as compared to the prior art technology of an one-way order processing mode. Moreover, the system and method for inquiring remaining quantity of orders allow the buyer and seller to both realize a current status of order processing precisely and immediately.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram showing configuration of a system for inquiring remaining quantity of orders according to a preferred embodiment of the invention;

FIGS. 2(A)-2(C) are schematic diagrams of displayed web pages through the use of a system and a method for inquiring remaining quantity of orders according to the invention; and

FIG. 3 is a flowchart showing process steps for a method for inquiring remaining quantity of orders according to a preferred embodiment of the invention.

### DETAILED DESCRIPTION OF THE PREFERRED EMBODIMENT

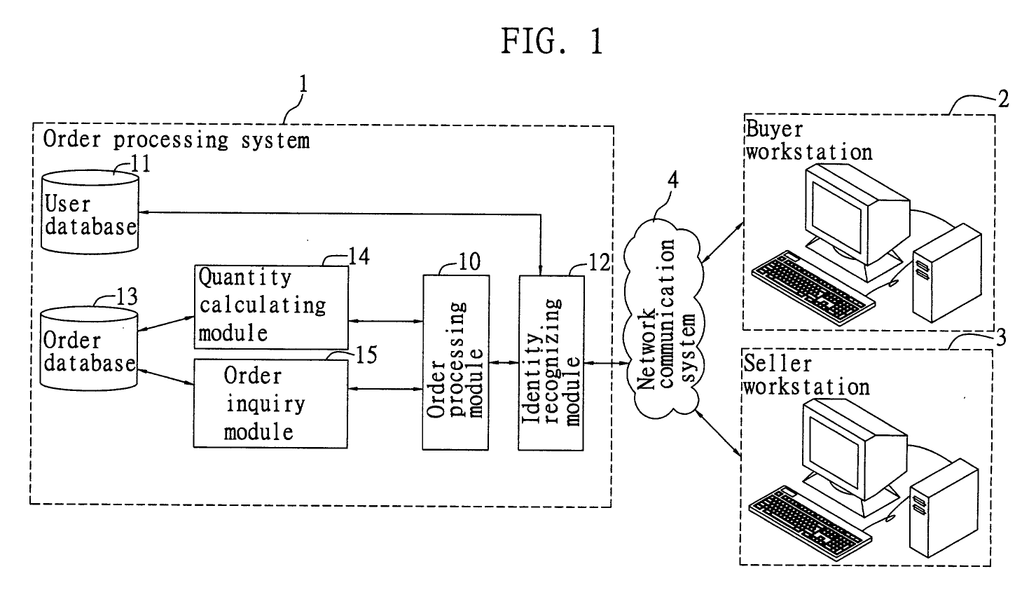

FIG. 1 illustrates configuration of a system for inquiring remaining quantity of orders according to a preferred embodiment of the invention. As shown in FIG. 1, the system for inquiring remaining quantity of orders at least comprises: an order processing system 1, at least a buyer workstation 2, and at least a seller workstation 3, wherein the buyer and seller workstations 2, 3 are respectively linked to the order processing system 1 via a network communication system 4 such as Internet. The buyer and seller workstations 2, 3 can be computer systems primarily containing Internet-browsing programs such as Microsoft Internet Explorer or Netscape Navigator. The order processing system 1 is an application program for processing purchase orders between buyers and sellers respectively at the buyer workstation 2 and the seller workstation 3. The order processing system 1 can be stored in a website server (not shown), for allowing buyers and sellers to desirably inquire quantity data of unprocessed orders and orders with undelivered products through the use of the system for inquiring remaining quantity of orders according to the invention. The order processing system 1 comprises: an order processing module 10, a user database 11, an identity recognizing module 12, an order database 13, a quantity calculating module 14, and an order inquiry module 15.

The order processing module 10 is used to receive requests, such as inquiry for quantity data of unprocessed orders and orders with undelivered products, from buyers and sellers at the buyer or seller workstation 2, 3. Then, the order processing module 10 proceeds with appropriate responses corresponding to the received requests (described in detail later), and transmits responding data through the network communication system 4 to the request-generating buyer or seller workstation 2, 3 where the responding data are displayed by the Internet-browsing programs.

The user database 11 is used to store a plurality of users' basic data, wherein each record of the users' data corresponds to an identification code. The identification code can include a login account and a password of a user who logs into the order processing system 1; with provision of the identification code, the order processing system 1 can recognize the user's identity and determine access rights of the login user.

When a user logs into the order processing system 1, the identity recognizing module 12 urges the user to input an identification code, and then retrieves access rights from the user database 11 corresponding to the inputted identification code. For example, with different access rights authorized to a buyer and a seller, when the buyer and seller respectively request for inquiry of processed order data, the order processing system 1 transmits different processed order data respectively to the buyer and seller workstations 2, 3 for display. That is, the buyer can only browse processed data for self-generated orders, and the seller can browse processed data of orders from different buyers.

The order database 13 is used to store detailed data of product orders, and can be linked via Intranet to a host e.g. EDI (electronic data interface) platform (not shown) or an ERP (enterprise resource planning) system, so as to receive electronic orders.

The quantity calculating module 14 is adapted to periodically search and calculate quantity data of unprocessed orders and orders with undelivered products from the order database 13, and the calculated results can be displayed on a web page of the system for inquiring remaining quantity of orders, so as to inform a user (buyer, seller) of a current status of order processing and product delivery.

When the order processing module 10 receives a request for logging into the order processing system 1 from a user (buyer, seller), after the identity recognizing module 12 identifies and verifies the user's identity and access rights, the order inquiry module 15 provides an inquiry table on the web page of the system for inquiring remaining quantity of orders, for allowing the user to input inquiry items and conditions; then, the order inquiry module 15 retrieves order data corresponding to the inquiry conditions and the user's access rights from the order database 13, and the retrieved order data are displayed on the web page.

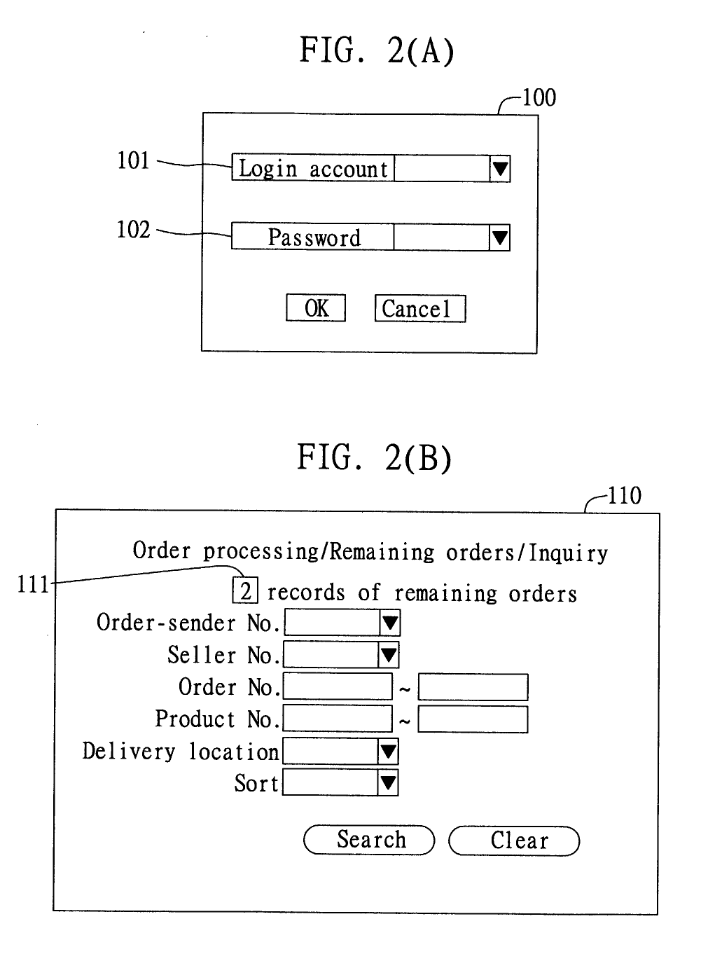

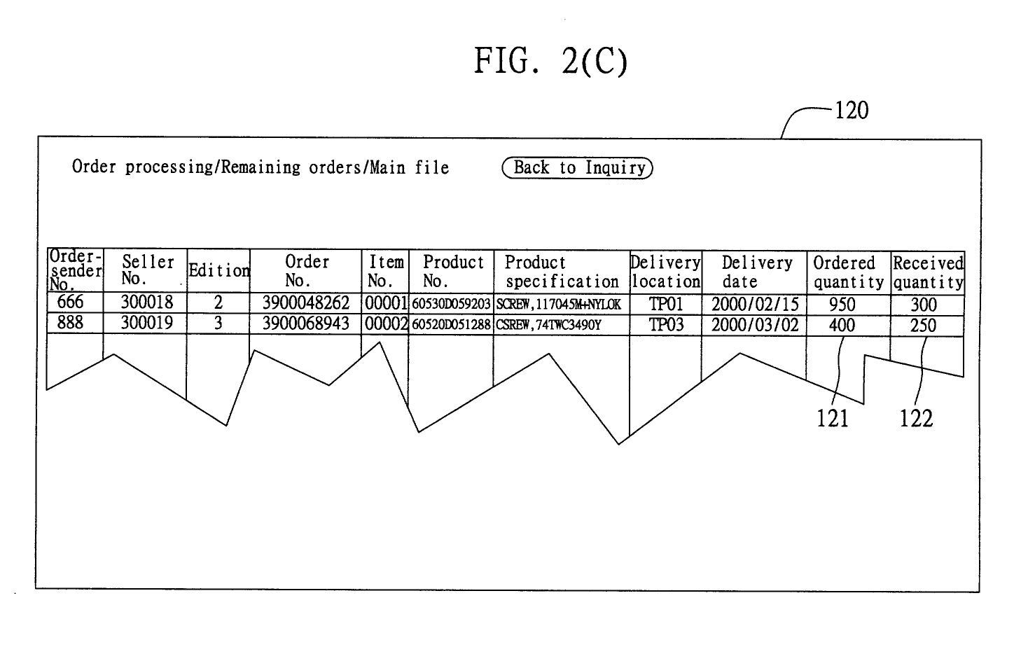

FIGS. 2(A)-2(C) illustrate displayed web pages in operation of the system for inquiring remaining quantity of orders according to the invention. Referring to FIG. 2(A), a web page 100 is displayed for allowing a user to input a login account and a password thereof. First, a user inputs a login account and a password thereof respectively into a login account field 101 and a password field 102 on the web page 100, whereby the identity-recognizing module 12 can search in the user database 11 for determining and verifying the user's identity and access rights according to the inputted login account and password.

Referring to FIG. 2(B), an appropriate web page 110 of the system for inquiring remaining quantity of orders is displayed corresponding to the user's access rights, for allowing the user to input inquiry conditions or items thereto. In the web page 110, a remaining order quantity field 111 displays the periodically-calculated quantity data of unprocessed orders and orders with undelivered products from the quantity calculating module 14; for example, the remaining order quantity is calculated to be two records of orders in this embodiment. Then, the order inquiry module 15 can search and retrieve detailed data of remaining orders from the order database 13 in response to the inquiry conditions inputted from the user.

Referring to FIG. 2(C), a web page 120 is illustrated for displaying the retrieved detailed data of remaining orders as inquired by the user through the use of the system for inquiring remaining quantity of orders. In the web page 120 for a record of purchase orders, an ordered quantity field 121 shows product quantity ordered by a buyer, and a received quantity field 122 shows product quantity received by the buyer from a seller, wherein difference between quantities in the ordered quantity field 121 and in the received quantity field 122 indicates quantity of ordered products undelivered from the seller to the buyer for this purchase order.

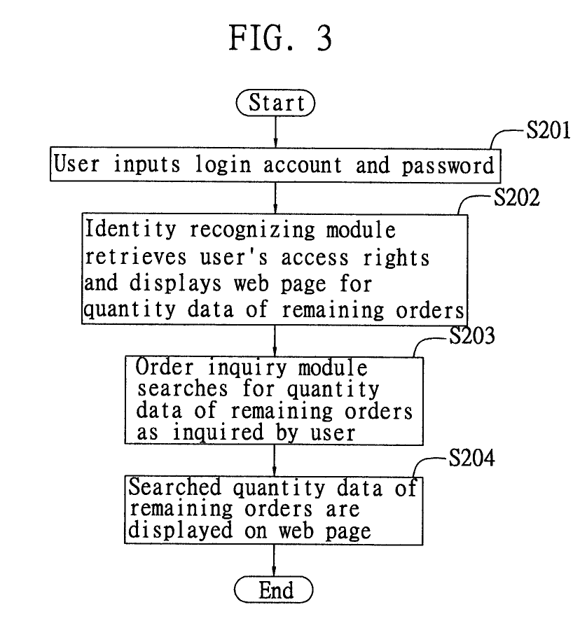

FIG. 3 illustrates process steps for a method for inquiring remaining quantity of orders through the use of the system for inquiring remaining quantity of orders according to the invention. First, the buyer workstation 2 or the seller workstation 3 is adapted to be linked to the order processing system 1 via the network communication system 4; then, it proceeds to step S201.

In step S201, a user inputs a login account and a password thereof through the buyer workstation 2 or the seller workstation 3 to the order processing system 1. Then, it proceeds to step S202.

In step S202, according to the inputted login account and password of the user, the identity recognizing module 12 searches in the user database 11 for determining and verifying the user's identity and access rights, and then displays an appropriate web page of the system for inquiring remaining quantity of orders corresponding to the user's access rights. The displayed web page illustrates periodically-calculated quantity data of unprocessed orders and orders with undelivered products from the quantity calculating module 14, so as to allow the user to input inquiry items or conditions. Then, it proceeds to step S203.

In step S203, the order inquiry module 15 searches and retrieves in the order database 13 for detailed data of remaining orders corresponding to the inquiry conditions inputted by the user. Then, it proceeds to step S204.

In step S204, the retrieved detailed data of remaining orders are displayed on the web page of the system for inquiring remaining quantity of orders.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for inquiring remaining quantity of orders, for linking terminal devices of a buyer workstation and a seller workstation through a network to an order processing system, wherein the order processing system at least includes a quantity calculating module, an identity recognizing module, an order inquiry module, a user database for storing a plurality of records of users' data and identification codes respectively corresponding to the records of users' data, and an order database for storing a plurality of orders generated from buyers; the method comprising the steps of:
periodically searching in the order database for data of unprocessed orders and orders with undelivered products by sellers via the quantity calculating module;
inputting an identification code via a user through a terminal device of a buyer workstation or a seller workstation, and retrieving access rights of the user via the identity recognizing module from the user database according to the inputted identification code, wherein if the user's access rights are retrieved, the user is allowed to input inquiry conditions for the searched data of unprocessed orders and orders with undelivered products to the order processing system; and
retrieving corresponding order data via the order inquiry module according to the user's access rights and inputted inquiry conditions, and displaying the retrieved order data through the network on the terminal device of the buyer or seller workstation of the user.

2. The method of claim 1, wherein if access rights corresponding to the user's inputted identification code are incapable of being retrieved by the identity recognizing module from the user database, the order processing system stops operation of data inquiry.

3. The method of claim 1, wherein the order processing system is established in at least a network server.

4. The method of claim 1, wherein the order database is linked to a host used to receive orders from buyers.

5. The method of claim 4, wherein the host is an ERP (enterprise resource planning) platform.

6. The method of claim 1, wherein the terminal device is a computer.

7. The method of claim 1, wherein the order processing system comprises:
the user database linked to a host used to receive orders from buyers, for storing a plurality of records of users' data;
the order database for storing a plurality of orders generated from buyers;
the quantity calculating module for periodically searching and calculating quantity data of unprocessed orders and orders with undelivered products by sellers from the order database;
the identity recognizing module for determining and retrieving access rights of a user from the user database according to an identification code inputted by the user through a terminal device to the order processing system; and
the order inquiry module for allowing the user with the determined access rights to input inquiry conditions for the quantity data of unprocessed orders and orders with undelivered products, and for retrieving from the order database for the inquired order data to be displayed to the terminal device of the user.

8. A system for inquiring remaining quantity of orders, for being linked with terminal devices of a buyer workstation and a seller workstation through a network, so as to perform ordering operation between buyers and sellers; the system comprising:
a user database linked to a host used to receive orders from buyers, for storing a plurality of records of users' data;
an order database for storing a plurality of orders generated from buyers;
a quantity calculating module for periodically searching and calculating quantity data of unprocessed orders and orders with undelivered products by sellers from the order database;
an identity recognizing module for determining and retrieving access rights of a user from the user database according to an identification code inputted by the user through a terminal device to the order processing system; and
an order inquiry module for allowing the user with the determined access rights to input inquiry conditions for the quantity data of unprocessed orders and orders with undelivered products, and for retrieving from the order database for the inquired order data to be displayed to the terminal device of the user.

9. The system of claim 8, wherein the system is established in at least a network server.

10. The system of claim 8, wherein the order database is linked to a host used to receive orders from buyers.

11. The system of claim 10, wherein the host is an ERP (enterprise resource planning) platform.

12. The system of claim 8, wherein the terminal device is a computer.
